(19) United States
(12) Patent Application Publication
(10) Pub. No.: US 2006/0259354 A1
(43) Pub. Date: Nov. 16, 2006

(54) Billing management system of parking facility

(76) Inventor: Chen Yan, Kaohsiung City (TW)

Correspondence Address: BACON & THOMAS, PLLC, 625 SLATERS LANE, FOURTH FLOOR, ALEXANDRIA, VA, 22314, US

(21) Appl. No.: 11/431,596

(22) Filed: May 11, 2006

(30) Foreign Application Priority Data
May 13, 2005 (TW) 094115756
Aug. 10, 2005 (TW) 094127074

(51) Int. Cl. G07B 15/00; G07B 15/02

(52) U.S. Cl. 705/13; 705/1

(57) ABSTRACT

A billing management system of parking facility mainly comprises: The vehicle enters the parking facility and initiates LOOP sensor to start up the voice operation instruction; The vehicle owner inputs the number of his cellular phone and selects the charging method for opening the gate bar to drive it into the parking facility for parking; When picking the vehicle to leave, the vehicle owner re-input the same cellular phone number as that during entering the parking facility so as to let the management system display or voice inform parking duration and the amount of the parking fee obligated; Next, the vehicle owner selects to pay the parking fee by cash payment on-site or by the telephone bill of his cellular phone to complete the parking fee payment so as to let the system print out the invoice or receipt; Then, the exit gate bar will open to let the vehicle owner drive his vehicle out of the parking facility. That effectively eliminates the printing and losing possibility of the park ticket or picking voucher and achieve the safe control effect in preventing the parking vehicle from stealing Meanwhile, it provides the vehicle owner the convenience in combination of cellular phone number as input method as well as promotes the manual management and running efficiency of the parking facility.

### FIELD OF THE PRESENT INVENTION

The present invention relates to the billing management system of parking facility mainly comprises: The vehicle enters the parking facility and initiates LOOP sensor to start up the voice operation instruction; The vehicle owner selects inputting the “identification code” or the number of his cellular phone for opening the gate bar to drive it into the parking facility for parking; When picking the vehicle to leave the vehicle owner re-input the same “identification code” or the number of his cellular phone so as to know the parking duration and the amount of the parking fee obligated; After completing the parking fee payment, the exit gate bar will open to let the vehicle owner drive his vehicle out of the parking facility. That effectively eliminates the printing and losing possibility of the park ticket or picking voucher and the torment caused by losing said park ticket or picking voucher as well as achieves the safe control effect in preventing the parking vehicle from stealing; Meanwhile, it promotes the manual management and running efficiency of the parking facility.

### BACKGROUND OF THE INVENTION

Presently, the equipment of the conventional billing management system of parking facility mainly comprises a LOOP sensor and a ticket dispenser for controlling the gate bar at the entrance/exit gate, as well as a voice operation instruction device and a park time & fee counter; by aids of manual operation and management to achieve the control and management of the parking fee billing facility for parking vehicles.

The managing way is shown as FIG. 1, when a vehicle enters the parking facility and initiates LOOP sensor, the voice operation instruction is started up to instruct the vehicle owner pushing the button on the ticket dispenser for the parking ticket; Then the gate bar opens in the meantime of the vehicle owner taking the park time counting ticket for the vehicle to drive into the parking facility for parking.

When the vehicle will leave the parking facility, the vehicle owner must go to the billing station first to hands the park time counting ticket, which he took when entering the parking facility, over clerk for calculating and collecting the parking fee by inputting the leaving time; After the vehicle owner completing the parking fee payment, the clerk gives a leaving voucher and an invoice or receipt; next the vehicle owner drives his vehicle to the exit for throwing in said leaving voucher; Then, the gate bar opens to allow the vehicle being driven out the parking facility for leaving.

However, the billing management way of such parking facility has been existing following drawbacks for a long time still not being solved yet:

(1) When the vehicle will leave the parking facility, the vehicle owner must hand the park time counting ticket, which he took when entering the parking facility, over clerk for calculating and collecting the parking fee as well as exchanging a leaving voucher and an invoice or receipt; If said park time counting ticket getting lost carelessly, not only the parking time and parking fee can not be exactly calculated but also the vehicle can not be allowed to leave; Thus, it causes much trouble and annoyance as well as senseless argument between the vehicle owner and the clerk of the parking facility.

(2) If said park time counting ticket was picked by a malignant people due to careless losing, the vehicle may be stolen by such people acting for paying the parking fee to drive out the parking facility; This also causes much trouble and annoyance as well as senseless argument between the vehicle owner and the clerk of the parking facility.

(3) For each parking vehicle, the parking facility must provide a park time counting ticket; This causes the meaningless waste of paper resources.

So, some businessmen improved the time-recording and billing management way aforesaid with additional CCTV camera connecting to a computer to video-record the vehicle identification number on the license plate of each vehicle during entering or exiting the parking facility for identification (such as the prior art of Japanese Patent No. 9-160966); But, such method can only achieve the verification of “the match of said park time counting ticket and leaving voucher with said vehicle” instead of achieving the safe effect of “verifying and ensuring the vehicle is leaving with the original authentic owner”. Hence, anyone can easily steal the vehicle by paying the parking fee to drive it out of the parking facility as long as he can pick said park time counting ticket, which recording the entrance parking time.

Namely, even if video-recording the vehicle identification number on the license plate of each vehicle during entering or exiting the parking facility for identification, it really only “replaces the computer connected video-recording and billing management way for the paper time-recording and billing management way to act as identification method; Such “only changing the form instead of content” method is not only unavoidable the vehicle being stolen without any effect in safe control but also increasing the cost of variety hardware and software in connecting CCTV camera with computer.

In other words, the aforesaid technology of conventional prior art by inputting the vehicle identification number for identification when picking said vehicle can be easily done by anyone instead of limiting to the operation by original authentic vehicle owner; Therefore, it does not have any effect in safe control as anyone can easily steal the vehicle by paying the parking fee to drive it out of the parking facility as long as he can enter said vehicle.

Moreover, the huge paper consumption in said park time counting ticket and leaving voucher of the conventional prior arts aforesaid becomes another burden in the environmental protection for decades accumulation; The vehicle-parking consumers are always the unfavorable losers owing to the suffering from the transferring of monetary cost in such paper consumption.

### SUMMARY OF THE INVENTION

The prime object of the present invention is to provide a billing management system of parking facility with operating way of the system is: The vehicle enters the parking facility and initiates LOOP sensor to start up the voice operation instruction; The vehicle owner inputs the number of his cellular phone and selects the charging method for opening the gate bar to drive it into the parking facility for parking; When picking the vehicle to leave, the vehicle owner re-input the same cellular phone number as that during entering the parking facility so as to let the management system display or voice inform parking duration and the amount of the parking fee obligated; Next, the vehicle owner selects to pay the parking fee by cash payment on-site or by the telephone bill of his cellular phone to complete the parking fee payment so as to let the system print out the invoice or receipt; Then, the exit gate bar will open to let the vehicle owner drive his vehicle out of the parking facility. That effectively eliminates the printing and losing possibility of the park ticket or picking voucher and achieve the safe control effect in preventing the parking vehicle from stealing Meanwhile, it provides the vehicle owner the convenience in combination of cellular phone number as input method as well as promotes the manual management and running efficiency of the parking facility.

The other object of the present invention is to provide a billing management system of parking facility with operating way of the system is: The vehicle enters the parking facility and initiates LOOP sensor to start up the voice operation instruction; The vehicle owner selects inputting the number of his cellular phone or selects pushing “show identification code” button for opening the gate bar to drive it into the parking facility for parking; When picking the vehicle to leave, the vehicle owner re-input the same cellular phone number or the “identification code” so as to let the management system display or voice inform parking duration and the amount of the parking fee obligated; Next, the vehicle owner selects to pay the parking fee by cash payment on-site or by the telephone bill of his cellular phone to complete the parking fee payment so as to let the system print out the invoice or receipt; Then, the exit gate bar will open to let the vehicle owner drive his vehicle out of the parking facility. That effectively eliminates the printing and losing possibility of the park ticket or picking voucher and achieve the safe control effect in preventing the parking vehicle from stealing Meanwhile, it provides the vehicle owner the convenience in combination of cellular phone number as input method as well as promotes the manual management and running efficiency of the parking facility.

### BRIEF DESCRIPTION OF THE DRAWINGS

FIG. 1 is the block flow chart of the conventional billing management system of parking facility.

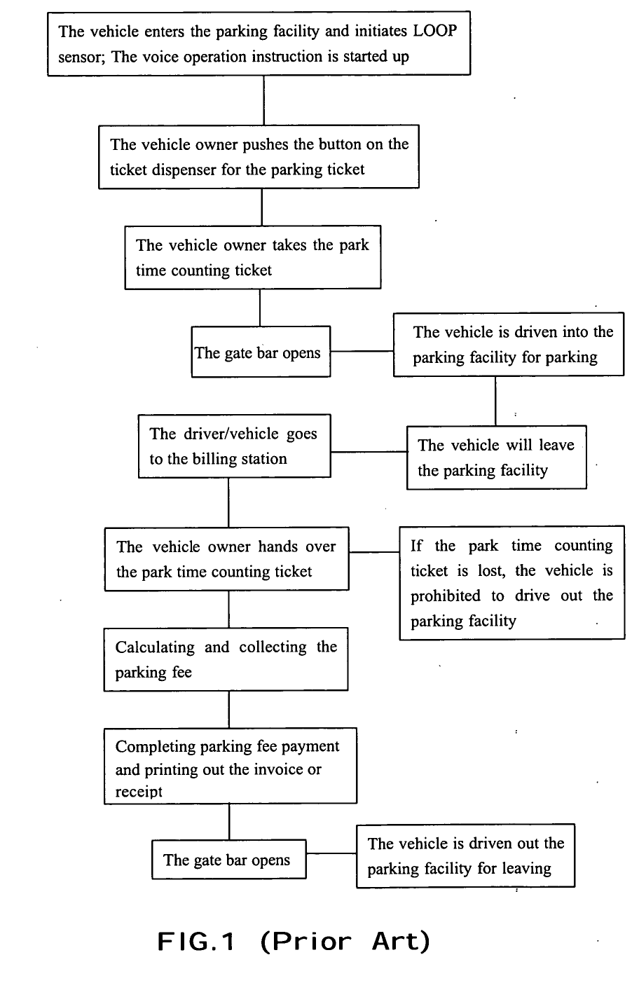

FIG. 2 is the illustrative flow chart in the first exemplary embodiment of the present invention.

FIG. 3 is the illustrative flow chart in the second exemplary embodiment of the present invention.

### DETAILED DESCRIPTION OF THE PREFERRED EMBODIMENTS

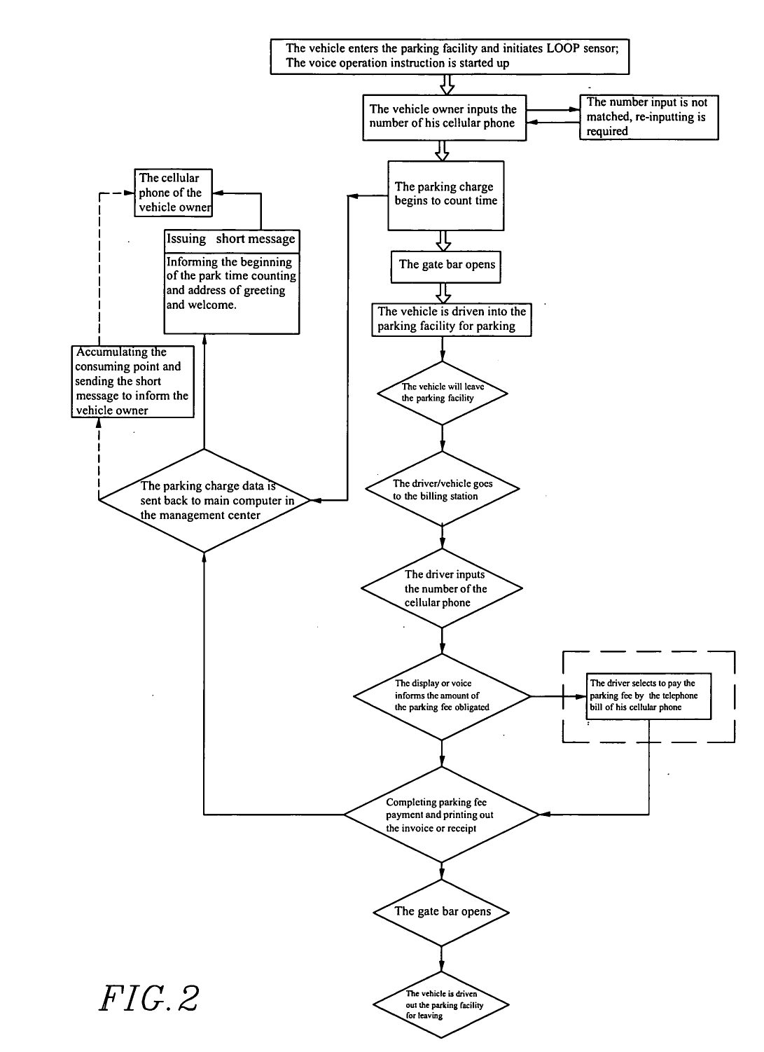

The shown as in the FIG. 2 is the first exemplary embodiment in one of the billing management system of parking facility of the present invention; It mainly comprises an electronic LOOP sensor for controlling the gate bar at the entrance/exit gate, a voice operation instruction device and a park time & fee counter for achieving the controlling and managing the billing system of parking vehicle. The operating way of the system is:

(a) The vehicle enters the parking facility and initiates LOOP sensor; Then, the voice operation instruction is started up.

(b) The vehicle owner inputs the number of his cellular phone and selects the charging method for opening the gate bar to drive it into the parking facility for parking; After parking, the vehicle owner can leave his vehicle without need to consult anyone; Wherein, the individual cellular phone number can be used as identification code in leaving the parking facility due to its uniqueness and retentiveness; The charging method can be counted by the duration or times selected by the vehicle owner; the system will automatically charge by duration counting if no selection;

If the digit number of the cellular phone number input is inadequate or not matched, said gate bar will not open and the voice operation instruction device will instruct the vehicle owner re-inputting meanwhile said gate bar keeping closed;

Moreover, after the parking charge system beginning, the parking charge data is sent back to main computer in the management center for processing; Then, said computer will issue short message of the beginning of the park time counting and address of greeting/welcome together with the accumulating consuming point to inform the vehicle owner via his cellular phone for his reconfirmation.

(c) When picking the vehicle to leave, the driver/vehicle goes to the billing station and input the same cellular phone number as that during entering the parking facility so as to let the management system display or voice inform parking duration and the amount of the parking fee obligated; Next, the vehicle owner selects to pay the parking fee by cash payment on-site or by the telephone bill of his cellular phone to complete the parking fee payment so as to let the system print out the invoice or receipt; Meanwhile, said computer will issue short message of the accumulating consuming point to inform the vehicle owner via his cellular phone for his reconfirmation.

(d) Then, the exit gate bar will open to let the vehicle owner drive his vehicle out of the parking facility.

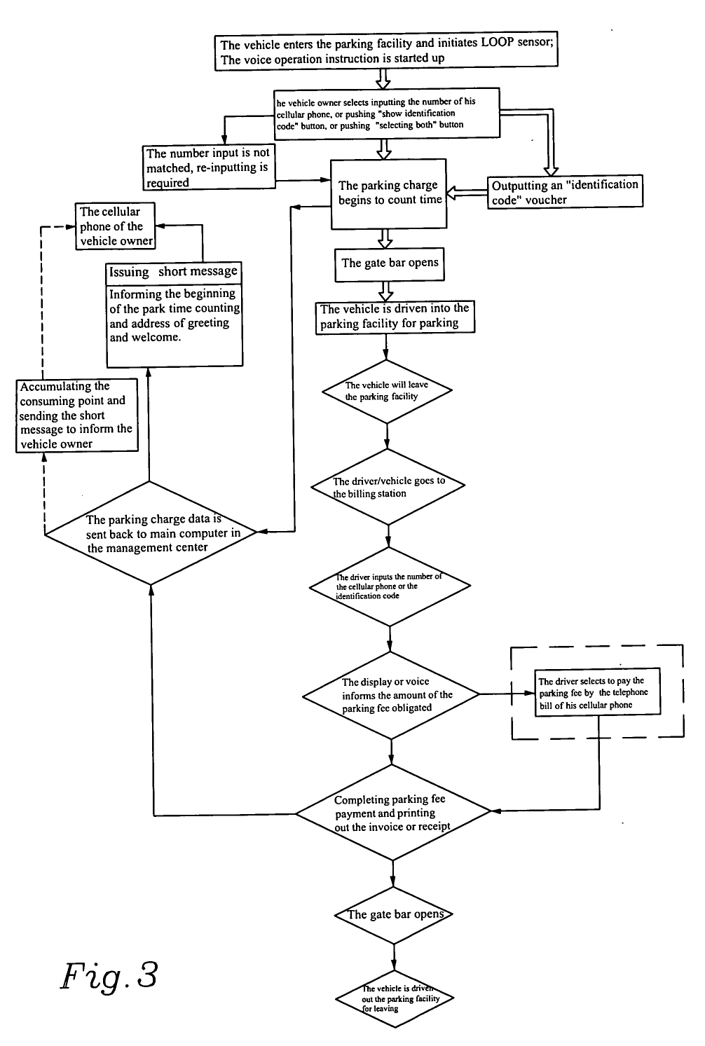

The shown as in the FIG. 3 is the second exemplary embodiment in one of the billing management system of parking facility of the present invention; It mainly comprises an electronic LOOP sensor for controlling the gate bar at the entrance/exit gate, a voice operation instruction device and a park time & fee counter for achieving the controlling and managing the billing system of parking vehicle. The operating way of the system is:

(a) The vehicle enters the parking facility and initiates LOOP sensor; Then, the voice operation instruction is started up.

(b) The vehicle owner selects inputting the number of his cellular phone or selects pushing “show identification code” button for opening the gate bar to drive it into the parking facility for parking; After parking, the vehicle owner can leave his vehicle without need to consult anyone;

(b-1) When selecting inputting the cellular phone number, the individual cellular phone number can be used as identification code in leaving the parking facility due to its uniqueness and retentiveness; The charging method can be counted by the duration or times selected by the vehicle owner; the system will automatically charge by duration counting if no selection; If the digit number of the cellular phone number input is inadequate or not matched, said gate bar will not open and the voice operation instruction device will instruct the vehicle owner re-inputting meanwhile said gate bar keeping closed; Moreover, after the parking charge system beginning, the parking charge data is sent back to main computer in the management center for processing; Then, said computer will issue short message of the beginning of the park time counting and address of greeting/welcome together with the accumulating consuming point to inform the vehicle owner for his reconfirmation.

(b-2) When the vehicle owner wants to drive into the parking facility quickly or to be reluctant to input long cellular phone number string, he can select directly pushing the “show identification code” button on the voice operation instruction device; Next, said voice operation instruction device will output an “identification code” voucher; and the parking charge begins to count time in the meantime; The charging method can be counted by the duration or times selected by the vehicle owner; the system will automatically charge by duration counting if no selection; Wherein, said “identification code” is selected via the computer random generating program without any duplication possibility; Hence the same “identification code” for two vehicles will not happen.

(c) When picking the vehicle to leave, the driver/vehicle goes to the billing station;

(c-1) If the vehicle owner selects inputting the cellular phone number when entering the parking facility, he must input the same cellular phone number so as to let the management system display or voice inform parking duration and the amount of the parking fee obligated; Next, the vehicle owner selects to pay the parking fee by cash payment on-site or by the telephone bill of his cellular phone to complete the parking fee payment so as to let the system print out the invoice or receipt; Meanwhile, said computer will issue short message of the accumulating consuming point to inform the vehicle owner via his cellular phone for his reconfirmation.

(c-2) If the vehicle owner selects pushing the “show identification code” button when entering the parking facility, he must input the same “identification code” on that voucher so as to let the management system display or voice inform parking duration and the amount of the parking fee obligated; Then, the vehicle owner pays to complete the parking fee payment so as to let the system print out the invoice or receipt.

(d) Then, the exit gate bar will open to let the vehicle owner drive his vehicle out of the parking facility.

Comparing the billing management system of parking facility in the present invention with that in the conventional prior art, some enhance effects with industrial application value of the present invention are validated and described below:

(1) Effectively eliminate the printing and losing possibility of the park ticket or picking voucher and achieve the safe control effect in preventing the parking vehicle from stealing as well as promote the manual management and running efficiency of the parking facility.

(2) Promote accounting efficiency in saving working process and hour by automatically printing out the financial report through revenue accumulating.

(3) The vehicle owner inputs his individual cellular phone number of uniqueness and retentiveness as identification code when entering the parking facility; That not only effectively eliminates the senseless argument between the vehicle owner and the clerk of the parking facility for correct recording the parking time but also ensures the rights and interests of both parties as well as parking efficiency.

(4) Under circumstances of long vehicle queue or the vehicle owner being reluctant to input long cellular phone number string, or wanting to drive into the parking facility quickly, the “leaving identification code” can be selectively obtained by directly pushing the “show identification code” button; That not only effectively expedites the entering into the parking facility but also provides more choice to satisfy with the discretion of vehicle owner as well as convenience in parking.

(5) The parking fee being able selected by the vehicle owner to pay by the telephone bill of his cellular phone makes the payment procedure more diverse and convenient.

(6) After the parking charge system beginning, the parking charge data is sent back to main computer in the management center for processing; Then, said computer will issue short message of the beginning of the park time counting and address of greeting/welcome to inform the vehicle owner via his cellular phone for his reconfirmation. Besides, when vehicle leaving, said computer will issue short message of the accumulating consuming point to inform the vehicle owner via his cellular phone for his reconfirmation. Those further promote the service quality in humanizing management of the present invention.

What is claimed is:

1. A billing management system of parking facility consist of an electronic LOOP sensor for controlling the gate bar at the entrance/exit gate, a voice operation instruction device, an automatic video-recording device and a park time & fee counter; The steps of the system comprises:
(a) The vehicle enters the parking facility and initiates LOOP sensor; Meanwhile, the voice operation instruction is started up, and the automatic video-recording device records the entrancing status with date, time and license plate etc of the vehicle;
(b) The vehicle owner inputs the number of his cellular phone and selects the charging method for opening the gate bar to drive it into the parking facility for parking; After parking, the vehicle owner can leave his vehicle without need to consult anyone; Wherein, the charging method can be counted by the duration or times selected by the vehicle owner; the system will automatically charge by duration counting if no selection;
Moreover, if the digit number of the cellular phone number input is inadequate or not matched, said gate bar will not open and the voice operation instruction device will instruct the vehicle owner re-inputting meanwhile said gate bar keeping closed;
(c) After the parking charge system beginning, the parking charge data is sent back to main computer in the management center for processing; Then, said computer will issue short message of the beginning of the park time counting and address of greeting/welcome together with the accumulating consuming point to inform the vehicle owner via his cellular phone for his confirmation; and
(d) When picking the vehicle to leave, the driver/vehicle goes to the billing station and input the same cellular phone number as that during entering the parking facility so as to let the management system display or voice inform parking duration and the amount of the parking fee obligated; Next, the vehicle owner pays the parking fee by cash payment on-site so as to get the invoice or receipt printed out; Then, the exit will gate bar to let the vehicle owner driving his vehicle out of the parking facility; Meanwhile, said computer will issue short message of the accumulating consuming point to inform the vehicle owner via his cellular phone for his reconfirmation.

2. A billing management system of parking facility as recited in claim 1, wherein the parking fee can be selected by the vehicle owner to pay it through the telephone bill of his cellular phone.

3. A billing management system of parking facility consist of an electronic LOOP sensor for controlling the gate bar at the entrance/exit gate, a voice operation instruction device, an automatic video-recording device and a park time & fee counter; The steps of the system comprises:
(a) The vehicle enters the parking facility and initiates LOOP sensor; Meanwhile, the voice operation instruction is started up, and the automatic video-recording device records the entrancing status with date, time and license plate etc of the vehicle;
(b) The vehicle owner selects inputting the number of his cellular phone or selects pushing “show identification code” button for opening the gate bar to drive it into the parking facility for parking; After parking, the vehicle owner can leave his vehicle without need to consult anyone;
(b-1) When selecting inputting the cellular phone number, the individual cellular phone number can be used as identification code in leaving the parking facility due to its uniqueness and retentiveness; The charging method can be counted by the duration or times selected by the vehicle owner; the system will automatically charge by duration counting if no selection; If the digit number of the cellular phone number input is inadequate or not matched, said gate bar will not open and the voice operation instruction device will instruct the vehicle owner re-inputting meanwhile said gate bar keeping closed; Moreover, after the parking charge system beginning, the parking charge data is sent back to main computer in the management center for processing; Then, said computer will issue short message of the beginning of the park time counting and address of greeting/welcome together with the accumulating consuming point to inform the vehicle owner for his reconfirmation;
(b-2) When the vehicle owner wants to drive into the parking facility quickly or to be reluctant to input long cellular phone number string, he can select directly pushing the “show identification code” button on the voice operation instruction device; Next, said voice operation instruction device will output an “identification code” voucher; and the parking charge begins to count time in the meantime; The charging method can be counted by the duration or times selected by the vehicle owner; the system will automatically charge by duration counting if no selection; Wherein, said “identification code” is selected via the computer random generating program without any duplication possibility; Hence the same “identification code” for two vehicles will not happen;
(c) When picking the vehicle to leave, the driver/vehicle goes to the billing station;
(c-1) If the vehicle owner selects inputting the cellular phone number when entering the parking facility, he must input the same cellular phone number so as to let the management system display or voice inform parking duration and the amount of the parking fee obligated; Next, the vehicle owner selects to pay the parking fee by cash payment on-site or by the telephone bill of his cellular phone to complete the parking fee payment so as to let the system print out the invoice or receipt; Meanwhile, said computer will issue short message of the accumulating consuming point to inform the vehicle owner via his cellular phone for his reconfirmation;
(c-2) If the vehicle owner selects pushing the “show identification code” button when entering the parking facility, he must input the same “identification code” on that voucher so as to let the management system display or voice inform parking duration and the amount of the parking fee obligated; Then, the vehicle owner pays to complete the parking fee payment so as to let the system print out the invoice or receipt; and
(d) Then, the exit gate bar will open to let the vehicle owner drive his vehicle out of the parking facility.

4. A billing management system of parking facility as recited in claim 3, wherein the parking fee can be selected by the vehicle owner to pay it through the telephone bill of his cellular phone.
